(19) United States
(12) Patent Application Publication
(10) Pub. No.: US 2001/0041247 A1
(43) Pub. Date: Nov. 15, 2001

(54) Fire-resistant print medium

(76) Inventors: Jacques Scheffer, Charly (FR); David Jean-Louis Lesueur, Saint Alban De Montbel (FR)

Correspondence Address: LERNER, DAVID, LITTENBERG,, KRUMHOLZ & MENTLIK, LLP, 600 SOUTH AVENUE WEST, WESTFIELD, NJ, 07090-1497, US

(21) Appl. No.: 09/834,019

(22) Filed: Apr. 12, 2001

(30) Foreign Application Priority Data
Apr. 12, 2000 (FR) 0004706

(51) Int. Cl. B41M 5/00

(52) U.S. Cl. 428/195

(57) ABSTRACT

A fire-resistant print medium comprises: backing forming the structure of the medium; and a coating covering the backing and used for printing; wherein:

the backing is made of inorganic fibers or yarns of mass F;

the coating is constituted by least one printable polymer of mass E; and

the ratio E/(E+F) lies in the range 4% to 50%.

### CROSS-REFERENCE TO RELATED APPLICATIONS

The present invention relates to the technical field of media of all kinds for receiving digital or silkscreen printing in order to make a printed medium for outdoor use (e.g. advertising posters) or for indoor use (posters of all kinds, whether for advertising or other purposes, as present in shops, offices, or other establishments).

The present invention relates to a medium for receiving digital or silk-screen printing, the medium comprising a backing forming the structure of the medium and a coating covering the substrate and used to receive the printing.

### BACKGROUND OF THE INVENTION

It is already known to make flexible media for printing on by the “digital printing” technique. In general, digital printing applies to two related fields, namely large-format digital printing and small-format digital printing.

In large-format digital printing, the area of the print medium is large, and for example of the order of several thousands of square meters (m²), and intended for outdoor use. By way example, this type of print medium can constitute posters of all kinds, such as cinema posters, or indeed lighted advertising posters placed along transport routes and known as “billboards”, or indeed posters or media for covering the faces of buildings or scaffolding.

Known media of this kind are generally made of backing based on vinyl paper, tarpaulin, scrim, non-woven cloth, carpeting, material for blinds, polypropylene film, acrylic film, or indeed ABS film, for example, the backing generally being coated in a covering suitable for receiving digital printing. Known media are all presented in the form of rolls of various lengths, for example about 30 meters (in) long.

Known coated media of the above type subsequently receive digital printing using an ink jet in a solvent medium, or less frequently in an aqueous medium, using various marking machines that are presently available on the market.

It is also possible to print such coated media using the silk-screen printing technique.

Although large-format coated media printed by digital printing or by silk-screen printing generally give satisfaction, they nevertheless suffer from certain drawbacks associated, for example, with the relatively high cost of the printing machinery needed and also essentially with their poor resistance to fire, even though such printed coated media are placed in or are integrated in places that are to receive the public.

Thus, most such large-format print media are unsuitable for complying with fire standards. This applies particularly to coated media based on paper backing which are combustible and therefore not fire-resistant. With coated media based on backing other than paper, the fire rating that such a media can obtain is at best an Ml rating (in compliance with standards NF P92-503 and NF P92-507) or a B1 rating (in compliance with standard DIN 4102) for example with PVC coated media, and that is, or can turn out to be, insufficient.

Media printed using the small-format digital printing technique are generally for use inside buildings, and are thus generally smaller in size. Applications include posters, whether for advertising or otherwise, placed in shops, offices, or public establishments, and such posters can also be lighted or back-lighted, or they can be in the form of lighted signs.

The printing techniques used are digital printing by aqueous ink jet or by electrostatic transfer. Compared with media suitable for printing using large-format digital printing techniques, the media printed using small-format digital printing techniques suffer from substantially the same drawbacks, but to a lesser extent concerning the cost of printing machinery that needs to be used, and also concerning levels of resolution. The same also applies to the drawbacks associated with the ability of such coated media to comply with regulations concerning fireproofing or non-flammability of the media, whenever such media are directly intended to be located in premises receiving or in contact with the public. It thus turns out that media for printing using small-format digital printing technology and made on the basis of paper type backing, adhesive backings or films, suffer from a drawback associated with their total inability to withstand fire or to their poor resistance to fire. With paper, the medium has no fire rating, whereas with certain coated media, they can at best comply with a fire rating of type M1 (standards NF P92-503 and NF P92-507) or B1 (standard DIN 4102).

Finally, in general, print media are known for forming protective coverings or tarpaulins, for example, said media being made from PVC-coated polyester fabric. Such print media can at best comply with the conditions for an M1 rating (standards NF P92-503 and NF P92-507). In addition to their unsatisfactory, or even practically non-existent, ability to withstand fire, such media are liable to give off various toxic vapors in the event of combustion, in particular hydrochloric acid vapor, which means that they cannot satisfy high-standard regulations.

### OBJECTS AND SUMMARY OF THE INVENTION

Consequently, an object of invention is to provide a novel print medium for printing using the digital printing technique or silk-screen printing, which medium does not have the above-described drawbacks and is capable of presenting improved characteristics of non-combustibility, while nevertheless being suitable for digital printing or for silkscreen printing.

Another object of the invention is to provide a novel print medium for digital printing or silk-screen printing, which medium is capable of satisfying particularly severe requirements for resisting fire, and is suitable for not giving off toxic vapor.

Another object of the invention is to propose a novel print medium for digital printing or silk-screen printing, which medium is suitable for retaining its non-combustibility characteristics before or after printing, regardless of the nature or the type of ink used.

An additional object of the invention is to propose a novel print medium for digital printing or silk-screen printing, and which is compatible with all available printing equipment.

Another additional object of invention is to propose a novel print medium for digital printing or silkscreen printing, which medium can be made from conventional backings and coatings, and can be made at a cost that is industrially acceptable.

The objects of the invention are achieved by a print medium for digital printing or silk-screen printing, the medium comprising:

a backing forming the structure of the medium; and

a coating covering the backing and used for printing; wherein:

the backing is made of inorganic fibers or yarns of mass F;

the coating is constituted by at least one printable polymer of mass E; and

the ratio E/(E+F) lies in the range 4% to 50%.

### DETAILED DESCRIPTION OF THE INVENTION

Other objects and advantages of invention are described in greater detail below in the light of the following description of purely illustrative examples.

In the invention, the term “digital printing” is used to include any printing by electrostatic transfer or by ink jet printing at any level of resolution, with printing pigment being provided by ink, whether based on water or on some other solvent.

In the meaning of the invention, the print media can also be printed by silk-screen printing.

According to the invention, the print medium for digital printing or silk-screen printing comprises:

a backing that is generally flexible, or that presents sufficient flexibility to enable it to be printed using conventional techniques, the backing forming the structure of the medium; and

a coating covering the backing and serving to enable printing to be performed using the above-mentioned techniques.

The backing is generally packaged in the form of a roll that can subsequently be cut to a plane shape suitable for a printer. It can be of a defined geometrical shape, e.g. rectangular, with the coating that forms the outer covering of the backing preferably extending over one face only, the face that is to receive the printing. In the meaning of the invention, it can nevertheless be envisaged that a coated support could have an outer covering on both opposite faces of the backing.

According to invention, the backing for coating is constituted by inorganic fibers or yarns or indeed filaments that are preferably not combustible, forming a mass F to be coated. The backing can thus be formed in non-limiting manner by glass cloth, by glass scrim, or indeed by non-woven fabric based on glass.

The coating forming the covering, e.g. superficial or to the core of the backing, is formed by at least one printable polymer of mass E applied by conventional techniques to the backing.

Printable polymers are advantageously selected from those suitable for being printed by an aqueous or a solvent ink using high resolution techniques (50 to 1200 dots per inch (dpi) or even more), so as to provide print media for use in the digital printing field.

By way of non-limiting example, the printable polymer layer could be applied to the backing using any conventional technique such as: coating, extrusion, coextrusion, brushing, pasting, spraying, or impregnating the polymer.

The invention thus consists in selecting incombustible inorganic fibers, yarns, or filaments and in coating them in a layer of printable polymers using a quantity such that the ratio E/(E+F) corresponding to the ratio of the mass of the coating divided by the total mass of the medium makes it possible to retain the incombustible nature of the entire medium both before and after printing. In the invention, the ratio E/(E+F) lies in the range 4% to 50%, (E/(E+F)×100%), with the lower limit, i.e. 4%, corresponding substantially to the minimum quantity of printable polymer needed to make printing possible. Of course, certain combinations of inks, printable polymers and backing may allow the ratio to be somewhat less than 4% and that is contemplated so long as the performance of the resulting material meets the other criteria of the invention. Advantageously, the minimum value can be raised to 7%, with the preferred average value being about 10%. This ratio only applies to that portion of the backing which is actually coated with printable polymer.

Advantageously, the medium of the invention has no compounds containing halogens such as chlorine, bromine, fluorine, or iodine, specifically to avoid any possibility of gases being given off in the event of the coated and printed medium burning, and so as to obtain a printable coated medium having fire-resistance properties that are further improved.

The coated and printable medium of invention can ensure that the medium is incombustible after printing with most of the types of ink that are in use. To this end, the medium advantageously contains a fire retardant suitable for lowering the oxygen index of the surface that is to receive the printing ink, to a value that is lower than that necessary for the ink to burn. Advantageously, the fire retardant is present in and/or dispersed through the printable polymer at a concentration that can lie in the range 0% (complete absence of fire retardant) to 90% of the coated mass, with the preferred value being about 25%. Naturally, the nature and the quantity of the fire retardant compound are determined on the basis of the nature and the composition of the ink, so as to be properly adapted to the desired characteristics of non-combustibility.

Nevertheless, the quantity of fire retardant must be adapted and determined by the person skilled in the art in conventional manner so as to remain within acceptable limits, and avoid excessively degrading the properties of the medium, and in particular its strength. By way of example, the fire retardants suitable for use advantageously contain phosphorus and/or nitrogen, the compound being in aqueous dispersion or in solution in a solvent.

Naturally, the printable polymer for forming the coating is selected so as to present a degree of solubility in water when printing is performed with an aqueous ink jet, or in solvent when printing is performed with a solvent ink jet.

Optionally, when the method of applying the coating needs to be performed mechanically, e.g. with the help of a wiper system, the coating can contain a quantity of thickening agent sufficient to obtain the necessary viscosity, e.g. about 20,000 m.Pa.s. The thickening agent is chosen in conventional manner by the person skilled in the art, and by way of example it can be based on casein, starch, etc.

In all cases, the calorific value of the printable coated medium of the invention is less than 10,000 kJ/kg, and preferably less than 2500 kJ/kg, with this applying both before and after printing so as to be capable of satisfying the strictest of standards concerning ability to withstand fire.

By complying with all of the above manufacturing characteristics, it is possible to obtain a coated print medium that is particularly good at withstanding fire and that can satisfy the strictest of the requirements of European or other regulations or standards. In particular, coated media obtained in accordance with invention can satisfy the criteria for the MO rating (standard NE P92-510) and for the A2 rating (standard DIN 4102-1).

Furthermore, it is found that media in accordance with invention are suitable for being printed using newly all presently-known printing machinery, of all kinds and whatever the type of ink used.

### EXAMPLES OF MANUFACTURED MEDIA ARE AS FOLLOWS

### Example 1

A printable medium was made for use with an aqueous ink jet on a printer having a width of 36 inches (91.44 centimeters (cm)), as follows:

the substrate was a glass fabric having continuous 68 tex yarn, the fabric weighing 205 grams per square meter (g/m²) referenced 3695 by Porcher Industries; and

the formulation of the coating was as follows:

Printable Polymer:

An aqueous dispersion of a modified aliphatic polyurethane referenced Rowathan 12892W from Rowa, 100 parts.

Oxygen Index Lowering Agent (Fire Retardant):

An aqueous dispersion based on a compound of phosphorus and nitrogen referenced FLACAVON®H14/112 from Schill and Seilacher, 16 parts.

Thickening Agent:

A sufficient quantity was added to obtain viscosity of about 20,000 m.Pa.s.

The dry extract of the bath was adjusted to be close to 26%. After being spread with a wiper over a single face of the fabric and after being dried, a translucent cloth was obtained that was coated with 15 g/m² to 20 g/n² of the above-described coating, and having an upper calorific value (as measured using standard NF P92-510) of less than 2500 kJ/kg, and of less than 4200 kWs/kg (using standard DIN 4102-1), thus enabling it to be given the following ratings that are respectively: MO and A2.

The cloth was then cut into rolls having a width of 36 inches and of various lengths for high resolution printing by means of an aqueous ink jet.

By way example, the printed cloth was suitable for use as a back-lighted advertising poster.

### Example 2

Example 1 was repeated, but replacing the above-specified glass cloth referenced 3695 with a glass satin obtained by weaving 136 tex continuous yarn, giving a weight of 420 g/m² and referenced 969 with Porcher Industries.

The coating had exactly the same formulation as in Example 1. Both faces of the satin were coated using a wiper so as to obtain 15 g/m² to 20 g/m² of the above-described coating on each face. This provided an opaque cloth suitable for printing with aqueous ink on both faces, having an upper calorific value as measured using standards NF P92-510 and DIN 4102-1 enabling it to be given ratings MO and A2 respectively. The cloth was then cut into 36-inch wide rolls of various lengths and suitable for high-resolution printing with an aqueous ink jet. The medium was also suitable for presenting at a width of 60 inches (152.4 cm) for aqueous ink jet printing. By way of example, this opaque cloth that is printable on both faces can be used for making signs for display in exhibition halls.

### Example 3

A print medium for solvent-based ink jet digital printing was made having a width of 2 m, as follows:

the backing was 68 tex continuous yarn glass scrim having 12 by 3.5 structure, i.e. 12 warp yarns per centimeter and 3.5 weft yarns per centimeter, giving a weight of 107 g/m², and referenced 3449 with Porcher Industries; and

the coating had the following the formulation:

Printable Polymer:

AGS 469 varnish from Holliday Dispersions which is a solution of an acrylic mixture in a solvent, with a dry extract of 25.9%: 100 parts.

Oxygen Index Reducing Agent (Fire Retardant):

A mixture of di- and tri-phosphonate cyclic compounds referenced EMTEX®L3309 from Wesserland: 7 parts.

After impregnation by padding and after the formulation had dried, an impregnated scrim was obtained having 4% to 6% of the above-described coating, i.e. 4.3 g/m² to 6.4 g/m² of coating, thus making it possible to comply with the MO rating of standard NE P92-510 and with the A2 rating and standard DIN 4102-1. This 2 m wide scrim was then cut into rolls of various lengths for digital printing using a solvent-based ink.

By way of example, the printable scrim can be used for making outdoor advertising posters of the billboard type.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A print medium for digital or silkscreen printing, comprising: a backing including inorganic fibers, inorganic yarn or inorganic filaments, said backing having a mass F; a printable polymer coating applied to at least a portion of said backing, said printable polymer coating having a mass E, and wherein the ratio of E/(E+F) for said medium is between 4% and 50% and said medium has a calorific value of less than 10,000 kJ/kg.

2. The print medium of claim 1 wherein said backing and said printable polymer coating contains substantially no halogens.

3. The print medium of claim 1 further comprising a fire retardant.

4. The printable medium of claim 3 wherein said fire retardant is dispersed in said printable polymer coating.

5. The printable medium of claim 4 wherein said fire retardant constitutes no more than 90% of said printable polymer coating.

6. The printable medium of claim 5 wherein said fire retardant constitutes about 25% of said printable polymer coating.

7. The printable medium of claim 1 having a calorific value less than 2,500 U.

8. The printable medium of claim 1 wherein said backing is a fabric of woven or non-woven glass.
